(19) United States
(12) Patent Application Publication
(10) Pub. No.: US 2009/0071503 A1
(43) Pub. Date: Mar. 19, 2009

(54) METHOD AND DEVICE FOR TREATING SUBSTRATES AND NOZZLE UNIT THEREFOR

(76) Inventors: Karsten Branz, Dettingen (DE); Peter Dress, Bruchsal (DE); Michael Sowa, Rottenburg (DE); Thomas Gairing, Bietigheim (DE)

Correspondence Address: ROBERT W. BECKER & ASSOCIATES, 707 HIGHWAY 333, SUITE B, TIJERAS, NM, 87059-7507, US

(21) Appl. No.: 11/718,675

(22) PCT Filed: Oct. 28, 2005
(86) PCT No.: PCT/EP2005/011533

§ 371 Date: Feb. 28, 2008

(30) Foreign Application Priority Data
Nov. 4, 2004 (DE) 10 2004 053 337.7

(51) Int. Cl. B08B 3/12; B08B 13/00; C23F 1/00

(52) U.S. Cl. 134/1; 134/144; 134/198; 216/83

(57) ABSTRACT

A method and device for treating substrates, and a nozzle unit therefore. A liquid film is formed on a local surface area of a substrate that is to be treated by means of a nozzle unit comprised of at least on elongated nozzle arrangement and an ultrasonic or megasonic transducer arrangement disposed adjacent to the nozzle arrangement. The transducer arrangement is composed of a plurality of transducers having different resonant frequencies. At least a portion of the transducer arrangement is brought into contact with the liquid film, and ultrasound or megasound is introduced into the liquid film by the transducer arrangement. The transducers are excited individually and/or in groups with different intensities and/or frequencies,

The present invention relates to a method and a device for treating substrates as well as to a nozzle unit for this purpose. In particular, the present invention relates to a method and a device for the surface treatment of substrates and especially substrates in the semiconductor field using a liquid in combination with ultrasound, and in particular, megasound.

It is known to clean components using ultrasound in the most varied of technological fields. Hereby, the components to be cleaned are brought into contact with a liquid medium, usually being dipped therein, and are exposed to ultrasound for a certain period of time in order to detach the impurities. Ultrasonic cleaning is also a recognized technique in the field of wafer and mask production and is already used in very many different ways.

An ultrasound system generally consists of a generator and an ultrasonic transducer, wherein the generator converts an alternating voltage into an appropriate operating voltage for the ultrasonic transducer. In turn, the latter converts the electrical energy into mechanical vibrations which cause positive pressure and negative pressure phases to develop in a liquid medium in contact therewith. So-called cavitations bubbles are produced by the alternating positive pressure and negative pressure phases and as a result very high local pressures and temperatures are created for a brief period when they implode. The cavitations bubbles form the basis for the ultrasonic cleaning technique. At a frequency above 400 kHz one speaks of ultrasound, and from a frequency of 700 kHz upwards of megasound. In the range covered by the megasonic frequencies, the cavitations energy is comparatively small so that destruction of microstructures is avoided. At the same time however, the cleaning efficiency for the smallest size of particles is very high in the megasonic frequency range. In consequences, megasound is usually used when producing wafers and masks.

In one known ultrasonic cleaning system such as is described in DE-A-197 58 267 for example, semiconductor wafers are inserted as a batch into a treatment basin filled with liquid and then exposed to ultrasound. Hereby, the ultrasonic sound waves are directed substantially parallel to the surface of the wafer and the entire surface of the wafer should be treated substantially uniformly.

On the basis of such a state of the art, the object of the present invention is to optimize ultrasound and in particular megasound treatment processes.

For the achievement of this object the present invention provides a method for the treatment of substrates, wherein a liquid film is formed on a locally bounded surface area of the substrate requiring treatment by means of a nozzle unit which comprises at least one elongated nozzle arrangement and an ultrasonic transducer, and in particular a megasonic transducer, arrangement arranged adjacent thereto, wherein at least one part of the ultrasonic transducer arrangement is brought into contact with the liquid film and thereafter, ultrasound and in particular megasound is introduced into the so formed liquid film. The method in accordance with the invention is suitable for the employment of ultrasound, wherein it is preferred that sound in the megasonic frequency range be utilized. This method enables surface areas of a substrate requiring treatment to be treated in a locally limited manner using liquid and ultrasound so that the treatment can be optimized for this particular surface area. Furthermore, a treatment can be effected with just a small quantity of liquid due to the local application of a liquid film, wherein consumption of the medium can be minimized. It should be noted hereby, that the surface of the substrate can be at least partly moistened with a liquid even prior to the local application of the liquid film, and that additional liquid can be deposited on the substrate in addition to the formation of a local liquid film by the nozzle arrangement. Furthermore, it should also be mentioned that after the local formation thereof , the liquid film can spread out and thus cover larger partial areas and possibly the entire surface of the substrate. The liquid film can be formed by liquids in the classical sense thereof as well as by a medium in the supercritical state.

In a preferred embodiment of the invention, the liquid film is formed between a substantially closed base structure of the nozzle unit and the surface area of the substrate to be treated in order to enable a well defined homogeneous liquid film to be formed, and this in turn assists in the provision of a defined treatment with ultrasound.

Preferably, a relative movement between the nozzle unit and the substrate is produced in order to enable the liquid film to be deposited on different surface areas of the substrate and to introduce the ultrasound into the liquid film in these areas. This thereby enables a large area of the surface and possibly the entire surface area of the substrate to be treated, wherein it is possible to optimize the treatment with the liquid and the ultrasound for different surface areas. An optimization of this type is, for example, possible by varying the relative movement between the nozzle unit and the substrate, wherein the time period for which the liquid film and the ultrasound are effective is altered, and hereby, the speed of the relative movement is preferably altered in dependence on the position of the nozzle unit relative to the substrate.

As a further possibility for the optimization of the treatment, it is possible to vary the introduction of the ultrasound into the liquid film during the treatment. Hereby for example, the introduction of the ultrasound can be varied in dependence on the position of the nozzle unit relative to the substrate. Thus, in one embodiment of the invention, the intensity and/or the frequency of the ultrasound introduced into the liquid film can be altered in order to correspondingly change the effect of the ultrasound on the surface area. Here, what is meant by a change in frequency is a relatively small deviation with respect to the resonant frequency of a transducer in order to detune the latter and hence alter the effectiveness profile of the transducer.

In a further embodiment of the invention, the angle of incidence of the ultrasound on the substrate can preferably be varied by positioning the ultrasonic transducer arrangement at an angle with respect to a surface of the substrate. The angle of incidence of the ultrasound with respect to the surface of the substrate is preferably varied between 105° and 75°. Both the change in the intensity and/or the frequency of the ultrasound and also the change of the angle of incidence of the ultrasound can be utilized for deliberately producing cavitations directly on the surface of the substrate. Nevertheless, intentional detuning of the effectiveness profile is, for example, also possible in order to produce cavitations at a distance away from the surface of the substrate so as to protect sensitive surface structures for example. Optimization of the treatment can then be effected without destroying the structure.

In a particularly preferred embodiment of the invention, the ultrasonic transducer arrangement is built up from a plurality of ultrasonic transducers which are controlled individually and/or in groups in order to produce different amounts of ultrasonic sound and hence further locally optimized treatments within the locally bounded liquid film. This applies in particular when the liquid film extends over a larger surface area of the substrate, such as over the entire width of the substrate for example. The individual or group-wise control of the ultrasonic transducers then enables optimized treatment over the width of the substrate. Provision is preferably made for the transducers to have different resonant frequencies and to be arranged either in a row or in the form of a matrix in order to provide locally differing treatments. Hereby, the ultrasonic transducers are preferably controlled at different intensities and/or frequencies in order to enable individual optimization and/or matching of the transducers.

Preferably, the liquid film is formed substantially along a straight line over the entire width of the substrate and the ultrasound is introduced into the liquid film substantially along a straight line over the entire width of the substrate. This enables treatment to be effected over the entire surface of the substrate with highly localized optimization of the treatment process by means of a single movement of the nozzle unit over the substrate while appropriately controlling the nozzle unit arrangement(s) and the ultrasonic transducer arrangement. Hereby, the introduction of the ultrasound is preferably controlled in different manners over the width of the substrate so as to provide local optimization of the treatment process.

For a further matching or optimization of the treatment process, the composition of the liquid forming the liquid film is controlled. For the purposes of local optimization, the nozzle arrangement preferably comprises a plurality of nozzles which are controlled in different manners, this thereby enabling a local alteration of the treatment process to be effected along the nozzle arrangement. Hereby, different liquids and/or differing quantities of liquid are preferably applied locally to the substrate along the length of the nozzle arrangement for the purposes of forming the liquid film. Different liquids are also meant to include, in particular, liquids having different concentrations of a constituent.

In the preferred exemplary embodiment of the present invention, the liquid film is applied by means of at least two nozzle arrangements which are arranged on opposite sides of the transducer arrangement in order to ensure that the liquid film is formed very homogeneously in the vicinity of the transducer arrangement. In one embodiment of the invention, different liquids are supplied to the nozzles arranged on opposite sides of the transducer arrangement.

Preferably, an average spacing of from 0.2 to 2.0 mm and in particular of from 0.7 to 1.4 mm is maintained between the ultrasonic transducer arrangement and the surface of the substrate to be treated during the treatment process. Hereby for example, the spacing can be varied during the treatment in order to produce, in turn, a change of treatment, and in particular, local changes thereof.

In a particularly preferred embodiment of the invention, the liquid forming the liquid film contains a developer or an etching agent, wherein in this case the ultrasound ensures good contact between the surface of the substrate to be treated and the treatment medium so as to prevent particles being deposited on the surface. Furthermore, the ultrasound causes the developer to be well mixed so that local saturation of the liquid can be prevented.

In a further embodiment of the invention, the liquid forming the liquid film preferably contains a rinsing agent and/or a cleaning fluid, the ultrasound thereby assisting the efficiency of the cleaning process.

The object of the invention is also achieved by a device for treating substrates which comprises a nozzle unit including at least one elongated nozzle arrangement and an elongated ultrasonic transducer arrangement disposed adjacent to the nozzle arrangement, and in particular a megasonic transducer arrangement, wherein the at least one nozzle arrangement and the ultrasonic transducer arrangement point in substantially the same direction and wherein there is provided a moving device for the substrate and/or the nozzle unit for positioning them adjacent to a surface of the substrate in such a manner that the at least one nozzle arrangement and the ultrasonic transducer arrangement are directed toward the surface of the substrate at a defined distance therefrom. This device enables a liquid film to be produced locally on a surface area of a substrate to be treated and simultaneously enables subsequent treatment of the liquid film by means of ultrasound.

Preferably, the device comprises a control device for controlling a moving device in such a manner that the nozzle arrangement and the ultrasonic transducer arrangement are moved over the surface of the substrate at a defined distance therefrom in order to successively enable different surface areas of the substrate, and in particular to enable the entire surface of the substrate, to be treated successively, wherein the successive treatment can be locally adapted in each case by taking into consideration the surface structure of the substrate and/or the desired result of the treatment.

In a preferred embodiment of the invention, at least one further elongated nozzle arrangement is provided, wherein the ultrasonic transducer arrangement is arranged between at least two elongated nozzle arrangements. The provision of two elongated nozzle arrangements on opposite sides of the ultrasonic transducer arrangement assists in the formation of a defined liquid film in the region of the ultrasonic transducer arrangement. For the purposes of a well defined formation of such a liquid film, the at least two elongated nozzle arrangements are preferably directed towards a longitudinal central plane of the ultrasonic transducer arrangement.

For local optimization of the results of the treatment, the ultrasonic transducer arrangement is preferably formed from a plurality of ultrasonic transducers which are preferably arranged directly adjacent to one another in a row or in the form of a matrix. Furthermore, a control device is preferably provided for controlling the plurality of ultrasonic transducers individually and/or in groups in order to enable the treatment processes to be suitably adapted to local conditions. Preferably hereby, the frequency and/or the drive power or excitation power of the ultrasonic transducers is variable.

For setting the parameters of the treatment process, a device is preferably provided for adjusting the angle between a surface of the transducer arrangement and a surface of the substrate. The angle of incidence of the ultrasonic sound waves on the surface of the substrate can be adjusted thereby. The angle is preferably adjustable between 0° and 10°.

In one embodiment of the invention, the defined distance is adjustable to between 0.7 and 1.4 mm.

In a preferred embodiment of the invention a device is provided for supplying liquid to at least one nozzle arrangement for the purposes of forming a liquid film on a surface of a substrate to be treated. Preferably hereby, a control device is provided for supplying different liquids to different nozzle arrangements and/or different outlet nozzles of the nozzle arrangement(s), this thereby enabling local adjustment of the treatment over the entire length of the nozzle arrangement.

In a particularly preferred embodiment of the invention, the at least one nozzle arrangement and the ultrasonic transducer arrangement are provided in/on a common main body of the nozzle units and form a substantially closed base structure. This assists in the formation of a liquid film between two facing closed structures, i.e. the surface of the substrate and the closed base structure of the nozzle unit. Hereby, the substantially closed base structure protrudes relative to the remainder of the base structure in the region of the ultrasound arrangement, this thereby producing good contact between the ultrasound arrangement and a liquid film which is formed between a surface of the substrate being treated and the base structure.

The object of the invention is also achieved in the case of a nozzle unit including at least one elongated nozzle arrangement and an elongated ultrasonic transducer arrangement arranged adjacent to the nozzle arrangement, and in particular a megasonic transducer arrangement, wherein the nozzle arrangement and the ultrasonic transducer arrangement point in substantially the same direction and form a substantially closed base structure of the nozzle unit. A nozzle unit of this type enables a defined liquid film to be formed between a surface of the substrate and the closed base structure of the nozzle unit in a simple manner, and also enables selective and defined introduction of ultrasound into a liquid film formed in such a manner.

Preferably, at least one further elongated nozzle arrangement is provided, wherein the ultrasonic transducer arrangement is arranged between the at least two elongated nozzle arrangements so that a liquid may be supplied from both sides of the ultrasonic transducer arrangement, thereby assisting in the formation of a homogeneous liquid film. Hereby, the at least one elongated nozzle arrangement is directed towards a central plane of the ultrasonic transducer arrangement in order to assist in the selective and defined formation of a liquid film in the region of the ultrasonic transducer arrangement.

In a preferred embodiment of the invention, the ultrasonic transducer arrangement is formed from a plurality of ultrasonic transducers, wherein the transducers are preferably arranged directly adjacent to one another, in a row or in the form of a matrix. This enables the ultrasonic transducers to be separately controlled and thus allows local adjustment of the parameters of the treatment during a process of treating a substrate surface with a liquid and ultrasound.

The present invention is described in more detail hereinafter on the basis of an exemplary embodiment taken with reference to the drawings; in the drawings:

FIG. 1 shows a schematic perspective illustration of a nozzle unit in accordance with the present invention in relation to a substrate to be treated;

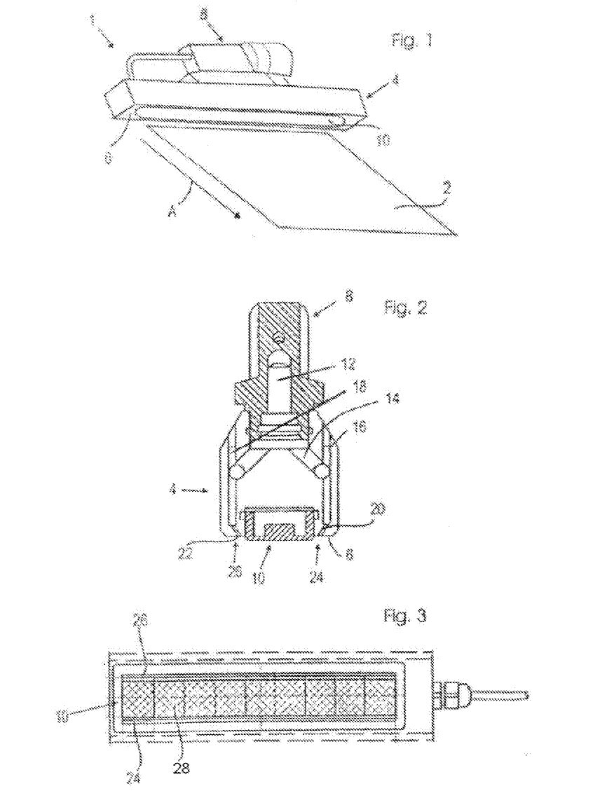

FIG. 2 a schematic sectional view of a nozzle unit in accordance with the present invention;

FIG. 3 a schematic view from below of a nozzle unit in accordance with the present invention,

FIGS. 4a and b schematic sectional views of a nozzle unit in accordance with the present invention having different alignments with respect to a substrate;

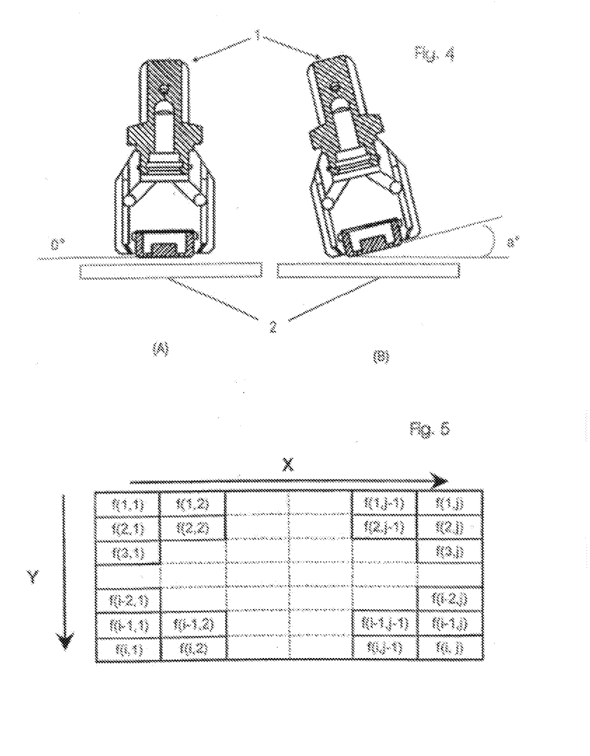

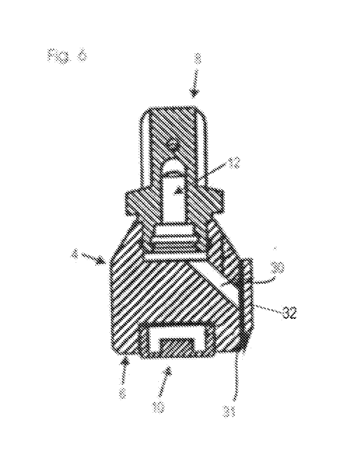

FIG. 5 a schematic illustration of an ultrasonic transducer arrangement in the form of a planar matrix in accordance with one embodiment of the invention;

FIG. 6 a schematic sectional view of a nozzle unit of the present invention in accordance with an alternative embodiment.

FIG. 1 shows a perspective view of a nozzle unit 1 which is useable for the treatment of a substrate 2 with liquid and ultrasound. Whereas ultrasound is used predominantly in this application, it is pointed out that this term is intended to cover megasound and the invention is meant for the surface treatment of substrates using megasound in particular.

The nozzle unit 1 comprises a substantially parallelepipedal main body 4 having a lower surface or underside 6 (also called base hereinafter), in which a plurality of outlet nozzles is formed, as will be described in more detail hereinafter. On the upper face of the main body 4, there is provided a media supply unit 8 which is connected to a not illustrated media supply source, as will be described in more detail hereinafter. The nozzle unit 1 is adapted to be moved over the substrate 2 in the direction of the arrow A by a not illustrated moving device such as a linear moving device. An ultrasonic transducer arrangement 10, whose construction will be described in more detail hereinafter, is provided in or on the base 6.

The construction of the nozzle unit 1 will now be described in more detail with the aid of FIG. 2, which depicts a schematic sectional view through the nozzle unit 1. The media supply unit 8 is depicted in an upper section of FIG. 2 and this comprises a media distribution chamber 12 into which different media can be introduced and mixed for example. The media distribution chamber 12, which is disposed substantially centrally above the parallelepipedal main body 4, is connected to respective supply lines 16 and 18 that extend substantially perpendicularly relative to the lower surface 6 of the main body 4 via respectively corresponding lines 14 which extend in an inclined manner in the main body 4. The supply lines 16 and 18 extend in parallel with the opposed long sides of the main body 4. The lower ends of the respective supply lines 16 and 18 are connected to a plurality of outlet bores 20 and 22 which open out at the lower surface 6 of the main body 4. The respective outlet bores 20 and 22 are each a component of nozzle arrangements which are arranged on opposite sides of the ultrasonic transducer arrangement 10, as is readily apparent from FIG. 2.

The nozzle arrangements 24, 26 and the ultrasonic transducer arrangement 10 have a linear dimension which corresponds at least to the width of a substrate to be treated in order to enable the entire surface of the substrate to be treated in the course of just one pass over the substrate.

As is apparent from FIG. 2, the ultrasonic transducer arrangement protrudes with respect to the outlet openings of the respective outlet bores 20 and 22. The lower surface 6 of the main body 4 and the ultrasonic transducer arrangement together 2 form a closed base structure of the nozzle unit 1.

As is further apparent from FIG. 2, the respective outlet bores 20 and 22 are inclined with respect to a longitudinal central plane of the main body 4 and extend toward the longitudinal central plane from the supply lines 16 and 18. In consequence, liquids emerging from the respective outlet bores 20 and 22 are directed towards the longitudinal central plane. The respective outlet bores 20 and 22 are each part of a nozzle arrangement 24, 26, which is formed by a plurality of outlet bores 20 and 22 arranged one behind the other in the plane of the paper. As an alternative, it is also possible to provide one or more slit-shaped nozzles in place of the outlet bores. A cooling agent channel for the passage of a cooling agent is provided on the back of the ultrasonic transducer arrangement 10 in order to cool the ultrasonic transducers. However, cooling could also be effected by a liquid film formed between a substrate to be cleaned and the nozzle unit.

FIG. 3 shows a schematic view from below of the nozzle unit 1, wherein the nozzle arrangements 24, 26 and the ultrasonic transducer arrangement 10 are schematically illustrated in the Figure. As is apparent from FIG. 3, the ultrasonic transducer arrangement 10 comprises a total of 9 rectangular ultrasound radiation elements which are controllable separately and/or in groups by a control device that is not illustrated in detail. In consequence, it is possible for the ultrasound to take different forms over the length of the nozzle unit 1, as will be described in more detail hereinafter.

FIGS. 4a and 4b each show a different arrangement of the nozzle unit 1 with respect to a substrate 2.

In accordance with FIG. 4a, the nozzle unit 1 is arranged in such a manner that a lower surface of the ultrasonic transducer arrangement 10 is aligned substantially parallel to an upper face of a substrate 2 to be treated. By contrast, FIG. 4b shows an inclined positioning of a lower surface of the ultrasonic transducer arrangement 10 with respect to a surface of a substrate 2 to be treated, as is indicated by the angle a shown in the Fig. This angle is preferably adjustable between 0° and 10°, as will be described in more detail hereinafter.

FIG. 5 shows an alternative type of arrangement for an ultrasonic transducer arrangement wherein a plurality of ultrasonic transducers is arranged in the form of a matrix in the x and y directions,

Operation of the nozzle unit 7 is described hereinafter.

The nozzle unit is first moved over a surface area of a substrate to be treated, in this case, a semiconductor wafer that is being subjected to a development process. A distance of between 0.7 and 1.4 mm is set up between a lower surface of the nozzle unit 1 and an upper surface of the substrate 2. Subsequently, a developer liquid is introduced into the media distribution chamber 12 from the media supply unit and is then fed via the lines 14 and the supply lines 16 and 18 to the respective outlet bores 20 and 22 of the nozzle arrangements 24 and 26. Hereby, the developer is a developing solution having a predetermined concentration which is set by the media supply unit 8 in a known manner.

In the following description. we assume first of all that the lower surface of the transducer arrangement 10 is aligned parallel to the upper surface of the substrate 2. A liquid film is now formed between the closed base structure of the nozzle unit and the surface of the substrate by the liquid emerging from the nozzle arrangements 24, 26 which is directed towards a longitudinal central axis of the nozzle unit 1. The liquid film completely fills the space between the surface of the substrate 2 and the base structure of the nozzle unit 1. Due to the fact that the ultrasonic transducer arrangement 10 protrudes with respect to the remaining lower surface of the nozzle unit 1, full contact between the ultrasound arrangement 10 and the liquid film is achieved.

Subsequently the ultrasonic transducer arrangement 10 is excited in a controlled manner such that ultrasound which is directed perpendicularly onto the surface of the substrate 2 is introduced into the liquid film. Due to the cavitations effect described above, the ultrasonic sound waves now cause particles to be released from the surface of the substrate 2, thereby ensuring uniform development of the surface of the substrate 2. In particulars detached resist or coating particles are whirled up by the ultrasonic agitation so that good and uniform contact of the developing solution with undissolved resist or coating layers can be achieved. This leads to an improvement in the uniformity of the result of the process independently of the size of the structures and the density distributions of the structures on the substrate surface. Furthermore, the processing time can be shortened by the improved exposure of the developer, which also makes it possible to decrease consumption of the medium.

After a predetermined treatment time in this position, the nozzle unit 1 is now moved over the substrate 2 in order to allow the ultrasound assisted treatment with the developing solution to be applied successively over the entire surface of the substrate 2. Naturally, it is also possible for the ultrasound assisted treatment with developing solution to be effected only in selected surface areas of the substrate.

In order to produce a specific and differentiated control of the treatment process in different surface areas of the substrate, there are control methods of the most varied type which can be employed with the basic procedures described above. For example, it is possible to control the different ultrasonic transducers in the ultrasonic transducer arrangement 10 in differing manners, wherein the transducers may be arranged as in FIG. 3 or in FIG. 5 for example. Hereby, it is possible for some of the ultrasonic transducers to be used as sensors in order to detect the amount of energy being supplied to the liquid film from adjacent ultrasonic transducers. Naturally hereby, it is also possible to swap the ultrasonic transducers between an ultrasound transmitter mode and a sensor mode so that all of the ultrasonic transducers can serve as sensors and transmitters over a period of time.

Due to the different manners of controlling the ultrasonic transducers, differing results for the treatment can be obtained over the width of the substrate, It is possible hereby for control to be exercised by using different frequencies as well as exercising control by the use of different excitation or drive powers. Thus, for example, the individual ultrasonic transducers are controllable at a power level of 0% to 100% of their maximum power, and the ultrasonic frequency is preferably adjustable between one megahertz and five megahertz.

As further control parameters for the surface treatment, it is possible to supply different liquids and/or different quantities of liquid over the length of the nozzle arrangement(s) 24 and/or 26. For example, a developing solution can be used in boundary regions of the substrate which has a different concentration as compared with that in a central region of the substrate. It is also possible to change the applied liquid (the type, concentration or quantity thereof) when passing over the substrate. Completely different results for the treatment of the surface of the substrate can thus be obtained locally over the length of the substrate, In addition, there may be a complete change in the medium being used, for example it is possible to replace the developing solution by a rinsing agent.

A further control parameter in accordance with the present invention is the angle of incidence of the ultrasonic sound waves on the substrate, which, as is illustrated in FIG. 4, is effected by an inclined positioning of the nozzle unit with respect to the surface of the substrate 2 to be treated. Inter alia, the input of energy into a liquid film by the ultrasonic sound waves can also be controlled if, for example, the ultrasonic transducers are not dipped completely into the liquid film since transmission of the ultrasonic sound waves can only occur where the ultrasonic transducers contact the liquid film.

A further manner of control lies in the setting of the relative speed between the nozzle unit and the substrate during its passage over the substrate, wherein the dwell times of the liquid film and the time of exposure to the ultrasonic sound waves are locally adjustable.

All of these different manners of control enable a process of adaptation, and in particular optimization of the surface treatment of the substrate in dependence on the nature of the local surface of the substrate or in dependence on a desired result from the process.

FIG. 6 shows a schematic sectional view of a nozzle unit of the present invention in accordance with an alternative embodiment. The same reference symbols as in the preceding embodiments are used in FIG. 6 insofar as identical or similar elements are being described.

The nozzle unit 1 shown in FIG. 6 again comprises a main body 4 having a lower surface 6. An ultrasonic transducer arrangement 10 is arranged in a recess in the lower surface 6. Furthermore, the nozzle unit 1 comprises a media supply unit S having a media distribution chamber 12 into which different media can be introduced and mixed for example. The media distribution chamber 12, which is disposed substantially centrally above the main body 4, is connected via a plurality of conduits 30 which extend in an inclined manner in the main body 4. The ends remote from the media distribution chamber each form an outlet nozzle which opens into a side face 31 of the main body 4. A baffle plate 32 extends substantially parallel to the side face 31 in such a manner that liquid emerging from the nozzles is directed onto the baffle plate and flows down it. A small capillary gap, which preferably expands slightly in the downward direction, is provided between the side face 31 and the baffle plate 32. Liquid emerging from the nozzles therefore flows down over the baffle plate and forms a substantially uniform curtain. The outlet nozzles in the side face 31 together with the baffle plate 32 form a nozzle arrangement, Hereby, the lower end of the gap between the baffle plate and the side face 31 of the main body 4 serves as a fluid outlet opening for the nozzle arrangement. The nozzle arrangement and the ultrasonic transducer arrangement thus point in substantially the same direction since a liquid emerging from the nozzle arrangement and also the ultrasonic sound emitted from the ultrasonic transducer arrangement are directed substantially perpendicularly relative to the lower surface 6 of the main body.

The construction of a nozzle arrangement including a baffle plate is, for example, known from the not prior published DE-A-102 32 984 belonging to the present Applicant, and to this extent reference is made thereto in order to avoid repetition. The subject matter of DE-A-102 32 984 is incorporated herein by reference,

A nozzle unit of this type has the advantage that the liquid film applied to a substrate can be applied thereto without any substantial use of force and furthermore, it enables a liquid film to be applied evenly to the substrate to be treated.

Again, different liquids and in particular liquids having differing concentrations of a developer or an etching agent within a carrier liquid can be applied over the length of the baffle plate by the plurality of lines 30. Although only one baffle plate is shown in FIG. 6, a second baffle plate can, for example, be provided on the side face located opposite the side face 31 in order to form a second nozzle arrangement.

The additional baffle plate could be supplied with a fluid via suitable lines corresponding to the lines 30. This enables the nozzle unit to be moved over the substrate in different directions by using an appropriate control scheme and hence it is possible to form a liquid film in both directions of movement. Furthermore, different liquids can be applied to a substrate via the nozzle arrangements. For example, a developing solution can be applied via a leading nozzle arrangement, which is located at the front in the direction of movement of the nozzle unit, while a neutralizing solution can be applied via a trailing nozzle arrangement, which is located at the rear in the direction of movement.

The nozzle unit 1 in accordance with FIG. 6 is substantially operated in the same as the manner as the nozzle unit described hereinbefore with respect to FIGS. 1 to 5, wherein in the case of the nozzle unit 1 in accordance with FIG. 6, liquid is only applied along a single line insofar as a second baffle plate is not provided.

The different aspects of the invention mentioned above can be freely interchanged and combined with one another.

Although the present invention has been described on the basis of a specific embodiment, it is not limited to this specifically represented embodiment. For example, it is not necessary for the nozzle unit and in particular the nozzle arrangements 24, 26 and the ultrasonic transducer arrangement to extend over the entire width of a substrate to be treated. It is also possible for example, to have only one of the nozzle arrangements insofar as this is sufficient for forming a defined liquid film on a substrate to be treated. Instead of passing the arrangement linearly over the substrate, this could also be done in the course of a pivotal movement for example. Naturally, it is also possible to move the substrate past the nozzle unit. In addition, the use of the nozzle unit is not limited to a treatment involving a developer. The nozzle unit can also be used, in particular, for etching processes and rinsing and/or cleaning processes. It is also possible for such processes to be effected successively using one and the same nozzle unit. The method in accordance with the invention is particularly suitable for semiconductor wafers, masks for use in the manufacture of semiconductors, and LCD displays.

1-52. (canceled)

53. A method of treating substrates including the steps of, comprising:
forming a liquid film, on a local surface area of a substrate to be treated, by means of a nozzle unit comprised of at least one elongated nozzle arrangement; and
an ultrasonic or megasonic transducer arrangement disposed adjacent to the at least one nozzle arrangement, wherein said transducer arrangement is composed of a plurality of transducers, and wherein said transducers have different resonant frequencies;
bringing at least a portion of said transducer arrangement into contact with the liquid film;
introducing ultra sound or mega sound into the liquid film via said transducer arrangement; and
exciting said transducers individually and/or in groups with different intensities and/or frequencies.

54. A method according to claim 53, wherein said step of forming a liquid film comprises forming a liquid film between a substantially closed base structure of said at least one nozzle arrangement and the surface area of the substrate to be treated.

55. A method according to claim 53, which includes a further step of producing a relative movement between said nozzle unit and the substrate for depositing the liquid film on different surface areas of the substrate and for introducing the ultrasound into these areas.

56. A method according to claim 55, which includes the further step of varying the speed of the relative movement between said nozzle unit and the substrate.

57. A method according to claim 56: wherein the speed of the relative movement is varied as a function of a position of said nozzle unit relative to the substrate.

58. A method according to claim 53, wherein said introducing step comprises varying introduction of ultrasound or megasound into the liquid film during treatment.

59. A method according to claim 58, wherein the introduction of ultrasound or mega sound is varied as a function of a position of said nozzle unit relative to the substrate.

60. A method according to claim 58, wherein an intensity and/or frequency of the ultrasound or megasound introduced into the liquid film is varied in at least a portion of said transducer arrangement.

61. A method according to claim 58, wherein an angle of incidence of the ultrasound or megasound on the substrate is varied via an inclined position of said transducer arrangement relative to a surface of the substrate.

62. A method according to claim 61, wherein the angle of incidence is varied between 105° and 75°.

63. A method according to claim 53, wherein said transducers are disposed in a row or in the form of a matrix.

64. A method according to claim 53, wherein the liquid film is substantially along a straight line over the entire width of a substrate, and wherein the ultrasound and megasound is introduced into the liquid film substantially along a straight line of the entire width of the substrate.

65. A method according to claim 53, wherein the introduction of ultrasound or megasound is controlled in different ways over the width of the substrate.

66. A method according to claim 53% which includes a further step of controlling the composition of the liquid that forms the liquid film.

67. A method according to claim 53, wherein at least one nozzle arrangement comprises a plurality of nozzles that are adapted to be controlled in different ways.

68. A method according to claim 66, which includes the further step of applying locally different liquids and/or different quantities of liquid to the substrate for forming the liquid film.

69. A method according to claim 53, wherein the liquid film is applied by means of at least two nozzle arrangements disposed on opposite sides of said transducer arrangement.

70. A method according to claim 69, wherein different liquids are applied to said at least two nozzle arrangements on opposite sides of said transducer arrangement.

71. A method according to claim 53, which includes a further step of maintaining an average spacing of from 0.2 to 2.0 mm, in particular of from 0.7 to 1.4 mm, between said transducer arrangement and the surface of the substrate to be treated.

72. A method according to claim 71, which includes the further step of varying the average spacing during treatment.

73. A method according to claim 53, wherein the liquid forming the liquid film contains a developer or an etching agent.

74. A method according to claim 53, wherein the liquid film contains a rinsing and/or cleaning fluid.

75. A method according to claim 53, which includes a further step of controlling at least one of said transducers periodically during introduction of ultrasound or megasound into the liquid film in such a way that it operates as a sensor.

76. An apparatus for treating substrates with a liquid and ultrasound or megasound, comprising:
a nozzle unit that includes at one elongated nozzle arrangement, for applying a liquid film onto a substrate, for applying a liquid film onto a substrate, and a transducer arrangement, disposed adjacent to said at least one nozzle arrangement for introducing ultrasound or megasound into a liquid film disposed on the substrate, wherein said transducer arrangement is disposed of a plurality of ultrasonic or megasonic transducers having different resonance frequencies, and wherein said at least one nozzle arrangement and said transducer arrangement point in substantially the same direction;
a movement device for at least one of the substrate and the nozzle unit to provide a positioning of said nozzle unit adjacent to a surface of the substrate such that said at least one nozzle arrangement and said ultrasonic or megasonic transducer arrangement are directed toward the surface of the substrate at a defined distance therefrom, and such that said transducer arrangement is adapted to contact a liquid film formed on the surface of the substrates; and
a control device for exciting said transducers individually and/or in groups.

77. An apparatus according to claim 76, which includes a further control device for controlling said movement device such that said at least one nozzle arrangement and said transducer arrangement are adapted to be moved over the surface of the substrate at a defined distance therefrom.

78. An apparatus according to claim 76, which includes one further elongated nozzle arrangement, wherein said transducer arrangement is disposed between said at least two elongated nozzle arrangements.

79. An apparatus according to claim 78: wherein at least one of said elongated nozzle arrangements is directed toward a central plane of said transducer arrangement.

80. An apparatus according to claim 76, wherein said transducers are disposed adjacent to one another, in a row, or in the form of a matrix.

81. An apparatus according to claim 76, which includes a further control device for varying the frequency and/or the energy that is adapted to be applied to said transducers.

82. An apparatus according to claim 76, which includes a device for setting an angle between a surface of said transducer arrangement and a surface of the substrate.

83. An apparatus according to claim 82, wherein said device is adapted to adjust the angle between 0 and ±15°.

84. An apparatus according to claim 76, wherein said defined distance is adapted to be adjusted by said movement device between 0.2 to 2 mm, and in particular between 0.7 and 1.4 mm.

85. An apparatus according to claim 76, which includes a device for supplying liquid to said at least one nozzle arrangement.

86. An apparatus according to claim 85, which includes a further control device for supplying different liquids to different ones of said at least one nozzle arrangement and/or to different ones of outlet nozzles of said at least one nozzle arrangement.

87. An apparatus according to claim 76, wherein said at least one nozzle arrangement and said transducer arrangement are disposed in or on a common main body and form a substantially closed base structure.

88. An apparatus according to claim 87, wherein said substantially closed base structure protrudes relative to a remainder of said base structure in the region of said transducer arrangement.

89. An apparatus according to claim 76, wherein said at least one nozzle arrangement and said transducer arrangement extend substantially parallel to one another.

90. An apparatus according to claim 76, which includes a further control device for controlling said transducers to serve either as a sensor for ultrasound or megasound or as generators for ultrasound or megasound.

91. A nozzle unit, comprising:
at least one elongated nozzle arrangement;
an ultrasonic or megasonic transducer arrangement disposed adjacent to said at least one nozzle arrangement, wherein said transducer arrangement is composed of a plurality of transducers, including transducers having different resonance frequencies, and wherein said at least one nozzle arrangement and said transducer arrangement point in substantially the same direction and form a substantially closed base structure of said nozzle unit; and
a control device for exciting said transducers individually and/or in groups.

92. A nozzle unit according to claim 91, which includes at least one further elongated nozzle arrangement, wherein said transducer arrangement is disposed between said at least two elongated nozzle arrangements.

93. A nozzle unit according to claim 92, wherein at least one of said elongated nozzle arrangements is directed toward a central plane toward said transducer arrangement.

94. A nozzle unit according to claim 91, wherein said transducers are disposed adjacent to one another, in a row, or in a plan of a matrix.

95. A nozzle unit according to claim 91, wherein said transducer arrangement and said at least one nozzle arrangement are substantially parallel to one another.

96. A method of treating substrates, including the steps of:
forming a liquid film on a local surface area of a substrate, by means of a nozzle unit having at least one elongated nozzle arrangement, wherein different liquids are adapted to be applied over a longitudinal extent of said at least one nozzle arrangement;
introducing ultrasound or megasound into the liquid film via an ultrasonic or megasonic transducer arrangement that is composed of a plurality of transducers, including transducers having different resonance frequencies; and
exciting said transducers individually and/or in groups with different intensities and/or frequencies.
